(19) United States
(12) Patent Application Publication
(10) Pub. No.: US 2024/0237698 A1
(43) Pub. Date: Jul. 18, 2024

(54) TRANSPORT APPARATUS AND METHOD FOR AUTOMATICALLY TRANSPORTING OBJECTS, SUCH AS SMOKING ARTICLES, OR THEIR COMPONENTS

(71) Applicant: I.M.A. INDUSTRIA MACCHINE AUTOMATICHE S.P.A., OZZANO DELL'EMILIA (IT)

(72) Inventor: Fiorenzo DRAGHETTI, OZZANO DELL'EMILIA (IT)

(21) Appl. No.: 18/561,880

(22) PCT Filed: May 20, 2022
(86) PCT No.: PCT/IT2022/050141

§ 371 Date: Nov. 17, 2023

(30) Foreign Application Priority Data
May 20, 2021 (IT) 102021000013214

(51) Int. Cl. A24C 5/32; B65G 47/57

(52) U.S. Cl. CPC A24C 5/326; A24C 5/328; B65G 47/57; B65G 2201/0226

(57) ABSTRACT

An apparatus for transporting objects, such as smoking articles or their components includes a plurality of transport members configured to each transport the objects along a working line from an initial position to a final position. A first guide parallel to the working line is configured to sequentially guide the transport members from the initial position to the final position, while a second guide, parallel to the first guide, is configured to sequentially guide the transport members from the final position to the initial position. Rotating displacement members are configured to selectively displace the transport members from one to the other of the two guides.

### FIELD OF THE INVENTION

The present invention concerns an apparatus and a method for automatically transporting objects, for example, smoking articles such as cigarettes or suchlike, or their components, such as for example casings, in an automated working line or machine, by the movement of a transport member, in which the objects can be positioned, for example, by means of automated members.

### BACKGROUND OF THE INVENTION

It is known that in the automated production of smoking articles, such as for example cigarettes, or suchlike, especially using machines with high productivity, one of the aspects to be taken into consideration and the technical problems to be overcome is the transport of the smoking articles from and toward one or more work stations.

The work stations can comprise, for example, a feed station, in which containing material, usually very thin paper, or other suitable material, possibly in the form of a casing including a filter, is positioned on, or in, one or more movement members. Furthermore, a filling station can be associated with the work station, in which, into the containing material, the smoking material, for example loose material, such as tobacco, other smokable substances, or a combination thereof, is deposited or inserted.

A packaging station, a distribution station and possibly also a station for packing the smoking articles can also be associated with the filling station.

With regard to the technical problem of transporting the smoking articles, it is known to provide one or more transport members in which to deposit the smoking articles. The transport member, containing the smoking articles, is subsequently moved between the various work stations to complete the production thereof.

To limit the sizes of the known machines used to automatically produce smoking articles, transport apparatuses with conveyor belts or other rotating members are generally used, normally having a work segment, from an initial point to an end point, and a return segment which makes the reverse path. Usually, the return segment is exactly below the work segment. One of the disadvantages of these known apparatuses is that the transport members, when they are in the return segment, that is, at a lower level, are subject to receive the waste produced from the working of the smoking articles, which fall from one or more of the work stations, for example a filling station, generally located on the upper transport level.

This technical problem is particularly relevant when it is desired to make smoking articles containing, for example, also leaf material other than tobacco, which has various peculiarities linked above all, but not only, to the chemical-physical characteristics of this material.

The fall of material from the upper level onto the transport members moved on the lower level, as well as dirtying the transport members, can compromise the correct functioning of the apparatus on which they are mounted. For example, if the smoking material that falls from the upper level is sticky and gluey, this could prevent the correct movement of the transport members and lead to the blocking of the entire apparatus.

Therefore, in the current state of the art, there are no known transport automated apparatuses and methods for automatically transporting objects in a machine for the production of smoking articles that also aim for high productivity, meaning, for example, an hourly production of 7,000 smoking articles.

In a technical field different from that of the packaging of smoking articles, in particular in the transport of pallets, there are also known transport apparatuses provided with an outward branch and a return branch equipped with a mechanism for transferring the transported pallets. An example of this transport apparatus is described in Japanese Patent Document JP 2021010956A. This apparatus is suitable for transporting bulky and heavy objects and is not optimized for the transport of small and light products such as smoking articles. Furthermore, it is evident that this apparatus does not allow to reach the high hourly productivity typical of the movement of products with a low unitary economic value.

Therefore, one purpose of the present invention is to provide a transport apparatus and to perfect a transport method for the automatic transport of objects, preferably smoking articles, which is simple and reliable and which at the same time allows to reach a high level of hourly productivity, as indicated above, by solving the technical problem described above.

Another purpose of the present invention is to provide a transport apparatus for the automatic transport of objects, preferably smoking articles, which, while using a transport path on two levels, ensures that any offcuts, powders or other working waste, do not compromise the proper functioning of the apparatus itself.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, a transport apparatus for transporting objects, such as smoking articles or their components, comprising a plurality of transport members independent of each other and configured to each transport one or more of said objects along a working line from an initial position to a final position, said transport apparatus also comprises first guide means parallel to the working line and configured to sequentially guide the one or more transport members from the initial position to the final position; second guide means parallel to said first guide means and configured to sequentially guide said transport members from said final position to said initial position; first displacement means and second displacement means, configured to selectively displace said plurality of transport members from one to the other of said first and second guide means, the first displacement means comprise a first rotating member disposed in correspondence with the final position configured to selectively displace, one at a time, the plurality of transport members from the first guide means to the second guide means, and the second displacement means comprise a second rotating member disposed in correspondence with the initial position configured to selectively displace the plurality of transport members, one at a time, from the second guide means to the first guide means.

According to another aspect of the present invention, the first rotating member is configured to selectively rotate, by means of a step-wise rotation about an axis of rotation, at least between a position of reception and a position of release, passing through a position of expulsion and a position of exclusion, different from the position of expulsion.

According to another aspect of the present invention, the apparatus also comprises a control device configured to detect any possible defects in the objects moved along the first guide means, expulsion means configured to expel the objects from the transport member toward an exit conveyor, when the transport member arrives in the position of expulsion, and discarding means configured to expel the objects which the control device has detected to be defective, from the transport member, when the transport member arrives in the position of exclusion.

The expulsion means and the discarding means are configured as actuation means configured to cause the objects to leave the first rotating member respectively in the positions of expulsion and exclusion.

According to another aspect of the present invention, the position of expulsion is located upstream of the position of exclusion when the transport member passes from the position of reception to the position of release.

According to another aspect of the present invention, the second rotating member is configured to rotate selectively, by means of a step-wise rotation about a respective axis of rotation, at least between a position of reception and a position of release. In a preferred embodiment, the first and second rotating members rotate about the same axis of rotation.

According to another aspect of the present invention, the step-wise rotation of the first rotating member and step-wise rotation of the second rotating member take place in angular steps of 90°, that is, these positions are separated by an angular step of 90°.

According to another aspect of the present invention, the first rotating member performs a rotation of 270° when it rotates between the position of reception and the position of release.

According to another aspect of the present invention, the first rotating member and the second rotating member rotate about the same axis of rotation disposed parallel to the first and second guide means so that the transport members are selectively displaced between the guide means according to a displacement that maintains the relative orientation of the transport members with respect to the working line unchanged. In other words, the transport members travel both the outward path on the first guide means and also the return path on the second guide means maintaining the same orientation, without rotating on themselves by 180° when they are displaced from one to the others.

According to another aspect of the present invention, the first rotating member and the second rotating member each comprise a plurality of rotating guides parallel to the first and second guide means, angularly distanced apart from each other in a uniform manner and each having substantially the same cross section of the first and second guide means, to temporarily house one of the transport members. Each rotating guide is rotatable about the axis of rotation to selectively bring itself into alignment with the first guide means or with the second guide means, in particular when the first rotating member and the second rotating member are respectively disposed in the first position of reception and in the position of release.

According to another aspect of the present invention, the second guide means are offset both horizontally and vertically with respect to the first guide means.

According to another aspect of the present invention, between the position of reception and the position of expulsion the transport member performs a 90° rotation.

According to another aspect of the present invention, the first expulsion means and the discarding means are the pneumatic type, being configured as nozzles able to selectively emit a flow of pressurized air which allows the objects to be expelled from the transport members.

According to another aspect of the present invention, each of the transport members comprises longitudinal guide elements. The first and second guide means have a respective cross section shaped so as to house guide members configured to cooperate with the longitudinal guide elements to allow the first and second guide means to slide only in the longitudinal direction.

According to another aspect of the present invention, the apparatus also comprises movement means, configured to selectively and alternatively move a first plurality of the transport members along the first guide means from the initial position to the final position and a second plurality of the transport members along the second guide means from the final position to the initial position and the movement means perform an alternating cyclic movement.

According to another aspect of the present invention, the movement means comprise first thrust means positioned in correspondence with the final position and second thrust means positioned in correspondence with the initial position. The first thrust means and the second thrust means are disposed at a fixed reciprocal distance between them and are configured to be moved in a coordinated manner, such that the reciprocal distance between them is fixed.

According to another aspect of the present invention, the expulsion means and the discarding means are fixed and disposed in proximity to the first rotating member.

According to another aspect of the present invention, a method for transporting objects, preferably smoking articles or their components, comprises a transport step in which one or more of the objects, mounted on a plurality of transport members, are transported sequentially along a working line from an initial position to a final position, guided by first guide means parallel to the working line; a return step in which second guide means parallel to the first guide means sequentially guide the plurality of transport members from the final position to the initial position; and a displacement step, interposed between the transport step and the return step, in which displacement means selectively displace the plurality of transport members, one at a time, from one to the other of the first and second guide means.

According to another aspect of the present invention, the displacement step provides to rotate the rotating members about an axis of rotation, disposed parallel to the first and second guide means, so that the transport members are selectively displaced from the first to the second guide means, or vice versa, with a movement that maintains the relative orientation of the transport members unchanged with respect to the working line.

According to another aspect of the present invention, the rotating members comprise a first rotating member configured to selectively rotate at least between a position of reception and a position of release passing through a position of expulsion and a position of exclusion different from the position of expulsion.

According to another aspect of the present invention, the method comprises a step of detecting, upstream of the first rotating member, the presence of a possible defect in the objects moved along the first guide means, an expulsion step to expel the objects from the transport member that has arrived in the position of expulsion toward an exit conveyor, and a discard step to remove from the transport member the objects that the control device has detected to be defective, when the transport member arrives in the position of exclusion.

According to another aspect of the present invention, during the displacement step, the first rotating member rotates by 270° to pass from the position of reception to the position of release.

According to another aspect of the present invention, a machine for the automatic production of smoking articles each having at least one casing, comprises at least one feed station configured to feed the casings, at least one filling station, configured to fill the casings with smoking material, at least one packaging station, configured to package the smoking articles by closing one end of the casings, and at least one transport apparatus configured to transport the casings from the feed station to at least one of the filling or packaging stations.

### ILLUSTRATION OF THE DRAWINGS

These and other aspects, characteristics and advantages of the present invention will become clear from the following description of some possible embodiments, provided by way of non-restrictive example, with reference to the attached drawings in which:

FIG. 1 is a three-dimensional and schematic view of a transport apparatus according to the present invention;

FIG. 2 is a block diagram of a machine which includes the apparatus in FIG. 1, or with which it can be associated;

FIG. 3 is a three-dimensional view, partly sectioned and on an enlarged scale, of a first detail of the apparatus in FIG. 1;

FIG. 4 is a cross section, on an enlarged scale, of a second detail of the apparatus in FIG. 1;

FIG. 5 is a front view of the apparatus in FIG. 1;

FIG. 6 is a section along the line VI-VI of FIG. 5, on an enlarged scale;

FIG. 7 is a section along the line VII-VII of FIG. 5, on an enlarged scale;

FIG. 8 is a rear view of the apparatus in FIG. 1;

FIG. 9 is a block diagram of a control circuit of the apparatus in FIG. 1;

FIG. 10 is a front view, partly sectioned, of a third detail of the apparatus in FIG. 1;

FIG. 11 is a front view, on an enlarged scale, of a smoking article that can be treated by the apparatus in FIG. 1.

It should be noted that in the present description and in the claims the phraseology and terminology used, such as the terms horizontal, vertical, high, low, internal, external, upper and lower, with their declinations, have the sole function of better illustrating the present invention with reference to the figures of the drawings and must not be used in any way to limit the scope of the invention itself, or the field of protection defined by the attached claims. For example, the term vertical refers to a plane that is orthogonal to the line of the horizon or inclined, even by several degrees, for example up to 20°, with respect to it.

In addition, persons of skill in the art will recognize that certain sizes, or features, in the figures may have been enlarged, deformed, or shown in an unconventional or non-proportional way, to provide a version of the present invention that is easier to understand.

When sizes and/or values are specified in the following description, the sizes and/or values are provided for illustrative purposes only and should not be construed as limiting the field of protection of the present invention, unless such sizes and/or values are present in the attached claims.

To facilitate understanding, identical reference numbers have been used, where possible, to identify identical common elements in the drawings. It should be understood that elements and features of one embodiment can be conveniently combined or incorporated into other embodiments without further clarification.

### DETAILED DESCRIPTION OF SOME EMBODIMENTS OF THE PRESENT INVENTION

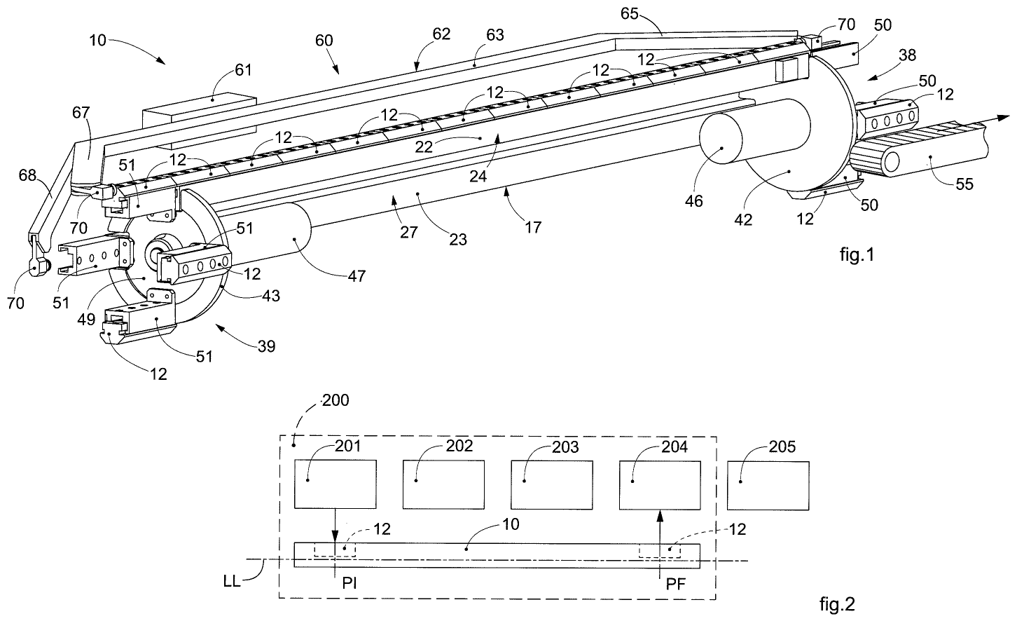

With reference to FIG. 1, a transport apparatus 10, according to the present invention, is configured to selectively and sequentially transport generic objects, for example smoking articles 100, from an initial position PI (FIGS. 2, 5 and 8) to a final position PF, and vice versa, of a working line LL (FIG. 2), which in the example provided here is horizontal and rectilinear, but could also be inclined and not rectilinear.

For example, the transport apparatus 10 can be associated with, or be part of, a machine 200 for preparing smoking articles, such as cigarettes, or suchlike, schematized in the block diagram in FIG. 2.

The machine 200 comprises, for example: a feed station 201 configured to selectively feed casings 101 for the smoking articles 100 to be made; a filling station 202 configured to fill the casings 101 with a smoking product, for example, loose material, such as tobacco, other smokable substances, or a combination thereof; a packaging station 203 configured to package the already filled smoking articles 100, for example to suitably close an open end 104 (FIG. 5) of each casing 101; and a distribution station 204 (FIG. 2), disposed for example in correspondence with the final position PF and configured to forward the smoking articles 100 to a packing station 205, possibly outside the machine 200, but is not limited thereto.

The feed station 201, the filling station 202, the packing station 203, the distribution station 204 and the packing station 205 can be of any known type, or which will be developed in the future. Alternatively, the filling station 202 can be, for example, of the type described in a related patent application for industrial invention filed by the same Applicant of the present patent application.

Before describing the apparatus 10 in detail, we will now describe an example of a smoking article 100, by way of non-restrictive indication (FIG. 11).

Each smoking article 100 comprises or consists of the casing 101 made of sheet material, for example very thin paper, cellulose, rubber or other material suitable to make a cigarette, and is normally provided with a filter 102 of a known type.

For example, each casing 101 can have a truncated-cone shape and comprise a first end 103 in correspondence with the filter 102, and the open end 104, opposite the first end 103 and through which the smoking material can be inserted for filling. Consequently, the first end 103 has a diameter smaller than the diameter of the open end 104. The length L1 of each casing 101 can vary according to the smoking article 100 to be obtained and is comprised, for example, between about 60 mm and about 150 mm, preferably between about 60 mm and about 120 mm.

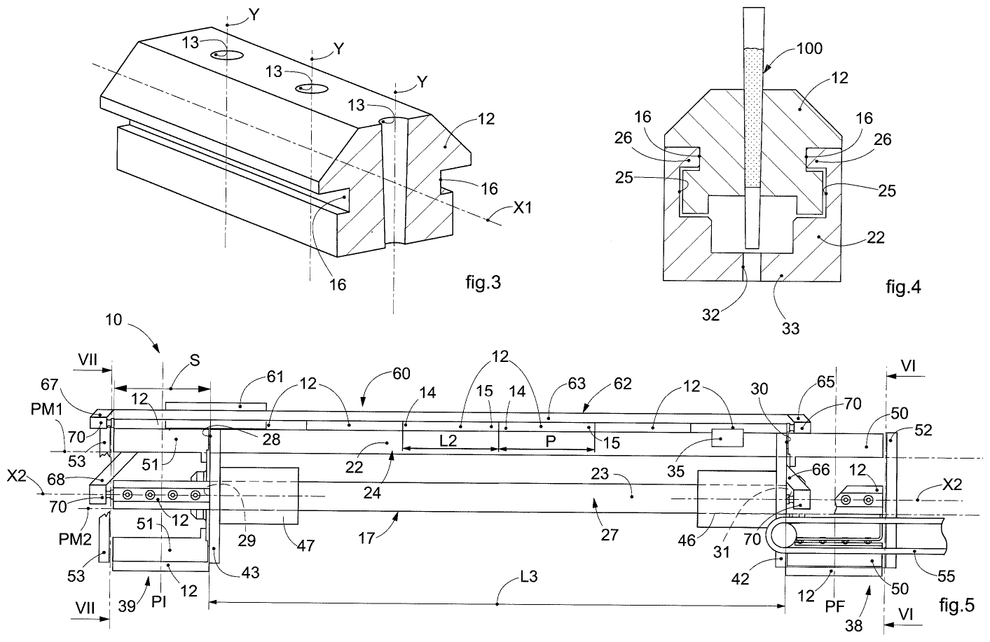

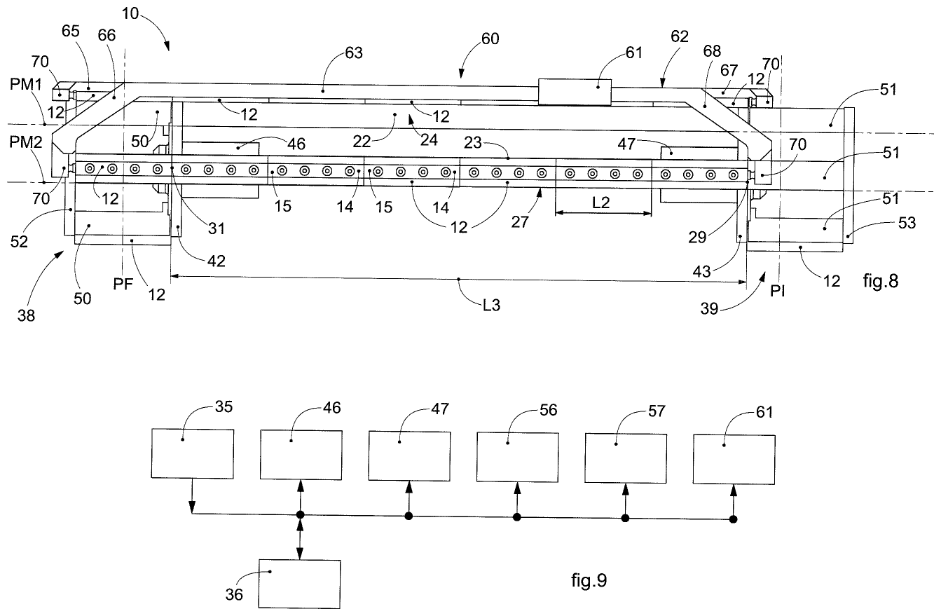

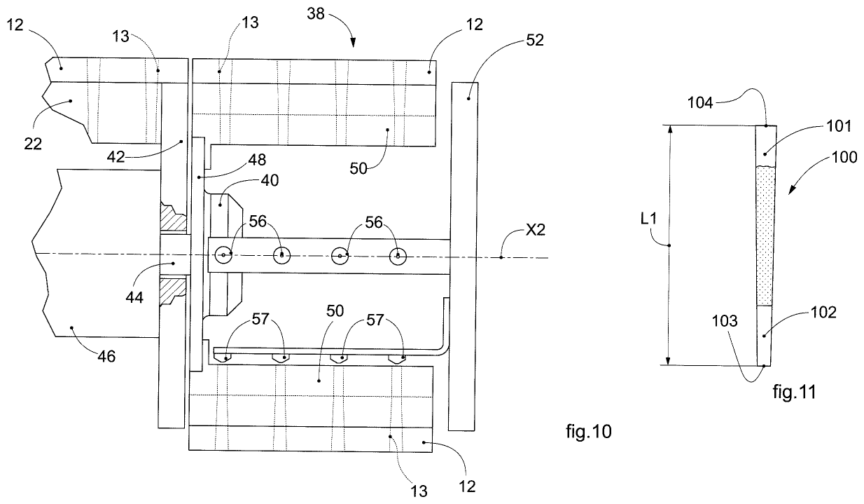

With reference to FIGS. 1, 5 and 8, the transport apparatus 10 comprises a plurality of transport members 12, each having the shape and function of a shuttle, configured to transport one or more smoking articles 100 (FIGS. 4 and 11) and having its own longitudinal axis X1 (FIG. 3). Each transport member 12 comprises a proximal end 14 and an opposite distal end 15 (FIGS. 5 and 8). During use, the proximal end 14 is always facing the initial position PI, and the distal end 15 is always facing the final position PF.

In the example given here, each transport member 12 comprises four through seatings 13, each coaxial to an axis Y perpendicular to the longitudinal axis X1 and having a truncated cone shape with sizes mating with those of a casing 101/smoking article 100, or at least of its lower part, so that the latter can be inserted from the top to the bottom and protrude downward by a few millimeters.

The distance between two adjacent seatings 13, as well as the length L2 of each transport member 12, is defined in the design phase of the apparatus 10 and/or of the machine 200 and is suitable to manage the plurality of smoking articles 100 to be transported and treated.

It is clear that the number of seatings 13 can also be different from four, even if this number affects the hourly productivity of the apparatus 10, as will be more evident from the following part of the description.

Each transport member 12 (FIG. 3) comprises two longitudinal guide grooves 16 made on two of its lateral surfaces, parallel to each other and perpendicular to the axes Y of the seatings 13.

The transport apparatus 10 also comprises a fixed support structure 17 (FIGS. 1 and 5), which in turn comprises first guide means 24, for example comprising a first fixed guide 22, and second guide means 27, for example comprising a second fixed guide 23. In the embodiment described here, the two fixed guides 22 and 23 are identical to each other.

In particular, the first fixed guide 22 lies on a first movement plane PM1 (FIG. 5) which is substantially horizontal, and is configured to allow the sliding, and therefore the advance, of the transport members 12 containing the smoking articles 100 between the initial position PI and the final position PF.

The second fixed guide 23, on the other hand, lies on a second movement plane PM2, parallel to the first movement plane PM1 and located in a lower position than the first, so that the two fixed guides 22 and 23 are horizontally offset. The second fixed guide 23 is configured to allow the sliding, and therefore the advance, of the transport members 12 containing the smoking articles 100 between the final position PF and the initial position PI, as will be described in detail below.

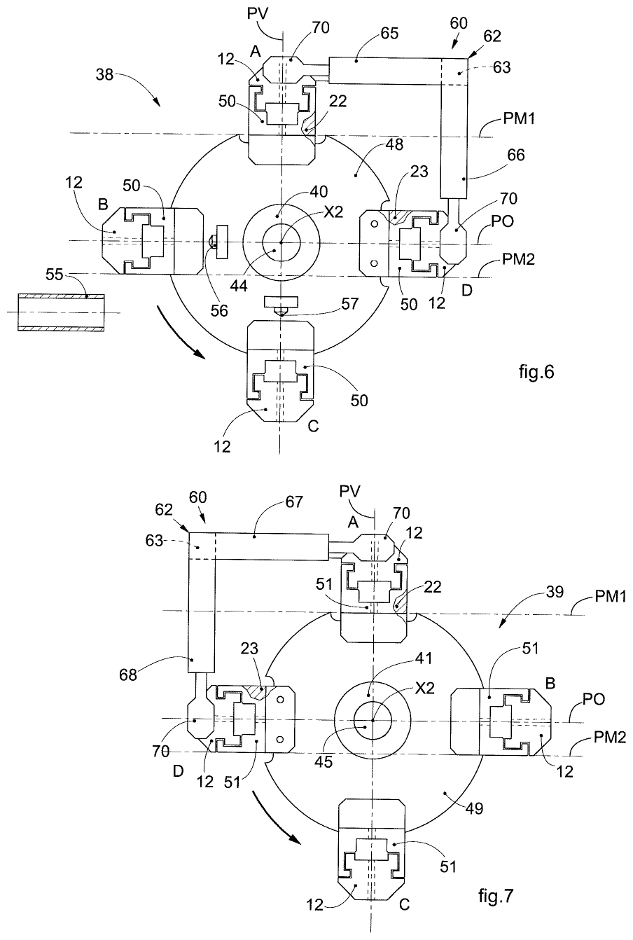

Furthermore, the second fixed guide 23 is also offset vertically, because it lies on a different vertical plane from that on which the first fixed guide 22 lies, in this case displaced toward the rear of the apparatus 10 (on the right in FIG. 6 and on the left in FIG. 7).

The two fixed guides 22 and 23 each have a length L3, equal to a whole multiple of the length L2 of a transport member 12.

Each of the two fixed guides 22 and 23 (FIG. 4) is shaped so as to have a longitudinal groove 25 which extends from one side to the other for the entire length L3 and defines two rails 26 opposite each other and parallel to the working line LL. The longitudinal guide grooves 16 of each transport member 12 cooperate with the two rails 26. In this way, each transport member 12 can only move parallel to the working line LL, in the manner that will be described in detail below.

Furthermore, the first fixed guide 22 and the second fixed guide 23 each comprise a first end 28, respectively 29, close to the initial position PI (on the left in FIG. 5) and a second end 30, respectively 31, close to the final position PF (on the right in FIG. 5).

In accordance with one aspect of the present invention, while the first fixed guide 22 has the external surfaces of the two rails 26 facing upward, the second fixed guide 23 has the external surfaces of the two rails 26 facing a rear side of the apparatus 10 (FIGS. 6 and 7), so that the external surfaces of the two rails 26 of the second fixed guide 23 are disposed on a plane perpendicular to the second movement plane PM2. Therefore, the two fixed guides 22 and 23 are offset with respect to each other by 90°. The reason for this design choice regarding the disposition of the second fixed guide 23 with respect to the first fixed guide 22 is explained below.

In some embodiments of the present invention, in a lower wall 33 (FIG. 4) of the first fixed guide 22 there are one or more through holes 32, the axes of which are equidistant from the two rails 26. In particular, the holes 32 can be made in correspondence with the filling station 202 and/or the packaging station 203 to allow generic service members, such as for example load cells, or actuators, to access the first ends 103 of the casings 101 from below, for functions that fall outside the field of protection of the present invention.

In correspondence with the second end 30 of the first fixed guide 22 a control device 35 is installed, of a type known per se and connected to an electronic control unit 36 (FIG. 11), for example of a programmable type. The control device 35 can be the optical type, such as a video camera, and is configured to detect any defects in the smoking articles 100 moved along the first fixed guide 22 and to send corresponding signals to the electronic control unit 36 (FIG. 9), so that it provides to discard the defective smoking articles 100, by means of discarding means 57, which will be described in detail below.

The apparatus 10 also comprises two rotating members 38 and 39 (FIGS. 1, 5 and 8), first and second respectively, coaxial with each other and disposed on opposite sides of the two fixed guides 22 and 23, that is, the first in the final position PF and the second in the initial position PI, with the function of selectively displacing the transport members 12 from one to the other of the two fixed guides 22 and 23, as will be described in detail below.

Each of the two rotating members 38 and 39 (FIGS. 6 and 7) comprises a central hub 40, respectively 41, rotatably mounted on a vertical plate 42, respectively 43, of the support structure 17 and is attached to a shaft 44, respectively 45, of an electric motor 46, respectively 47 controlled by the electronic control unit 36 (FIG. 11). The axes of rotation X2 (FIGS. 6, 7 and 8) of the two rotating members 38 and 39 are substantially coaxial and parallel to the two fixed guides 22 and 23.

In particular, the axis of rotation X2 is substantially disposed at the intersection of a vertical plane PV (FIGS. 6 and 7) substantially passing through the center line of the first fixed guide 22 with a horizontal plane PO passing substantially through the center line of the second fixed guide 23, that is, where the axes Y of the seatings 13 lie (FIG. 3).

On each of the two central hubs 40 and 41 (FIGS. 6 and 7) a disc 48, respectively 49, is attached, on which four rotating guides 50, respectively 51, identical to each other, are attached cantilevered, having a cross section equal to that of the fixed guides 22 and 23 and each distanced angularly by 90° with respect to the adjacent one. The two discs 48 and 49 are parallel to the vertical plates 42 and 43, while the rotating guides 50 and 51 are parallel to the fixed guides 22 and 23.

The length of each of the four rotating guides 50, 51 is equal to the length L2 of a transport member 12.

The two rotating members 38 and 39 are sized so that, when they are stationary, one of the four rotating guides 50, 51 is always aligned with the first fixed guide 22 and another of the four rotating guides 50, 51 is always aligned with the second fixed guide 23.

Two vertical plates 52 and 53 (FIGS. 5 and 8) of the support structure 17 are disposed parallel to the vertical walls 42, respectively 43, to prevent the transport members 12 present in the rotating guides 50 and 51 from coming out of them in an undesirable manner.

Furthermore, the two electric motors 46 and 47, commanded by the electronic control unit 36, are able to rotate the two rotating members 38 and 39 in reciprocally opposite directions, with angular increments of 90°.

For the convenience of the description, and with reference to FIG. 6, in which the first rotating member 38 is schematized, the following static positions in correspondence with which each transport member 12 can possibly stop are called as follows: position of reception A, where the first fixed guide 22 is located, that is, at the top; position of expulsion B, the front one, that is, at 90° in a counterclockwise direction with respect to the position of reception A and where, for example the distribution station 204 is located; position of exclusion C, the downward one, that is, 90° in a counterclockwise direction with respect to the position of expulsion B; and the position of release D, at the rear, where the second fixed guide 23 is located.

In FIG. 7, in which the second rotating member 39 is schematized, the position of release D is inverted with respect to that of FIG. 6, it being understood that this is the rear position of the apparatus 10. As will be evident from the following detailed description, the second rotating member 39 does not have a position of expulsion B and a discard position C since the transport members 12 in transit on the second rotating member 39 do not have the smoking articles 100, and therefore no position of expulsion or exclusion for these smoking articles is necessary.

Inside the first rotating member 38, there are the expulsion means 56, which are configured to displace the smoking articles 100 present on the transport members 12 toward the distribution station 204, which in FIG. 1 is shown schematically as an exit conveyor belt 55.

In particular, both the expulsion means and also the discarding means are configured as actuation members, they are fixed on the vertical plate 52 and are disposed between the four rotating guides 50 so as not to interfere with them during their rotation. In the example provided here, the expulsion means can comprise a first plurality of nozzles 56 positioned in correspondence with the position of expulsion B, and the discarding means can comprise a second plurality of nozzles 57, positioned in correspondence with the position of exclusion C. Each nozzle 56 and 57 is also aligned with a seating 13 of a transport member 12, when this is in the position of expulsion B, and respectively in the position of exclusion C.

Each nozzle 56 and 57 can selectively emit a flow of pressurized air, for example coming from compression means of any known type, not shown in the drawings and commanded by the electronic control unit 36.

In particular, the flow of pressurized air emitted by each nozzle 56 allows to expel a corresponding smoking article 100 possibly present in the seating 13 of the transport member 12 positioned in the rotating guide 50 toward the outside of the latter and therefore toward the conveyor belt 55.

On the contrary, each nozzle 57 can expel downward, possibly into a suitable container, not shown in the drawings, a corresponding smoking article 100, for example when this has previously been found to be defective by the control device 35.

The apparatus 10 also comprises a movement unit 60 (FIGS. 1, 5 and 8), mounted on the support structure 17 and configured to selectively and alternatively move the transport members 12 on the two fixed guides 22 and 23.

The movement unit 60 comprises an actuator 61, for example of the electric or fluid-dynamic type, known per se, controlled by the electronic control unit 36.

A slider 62 is connected to the actuator 61 (FIG. 1) comprising, for example, a central part 63, substantially horizontal and sliding with respect to the support structure 17.

Two pairs of lateral arms 65 and 66 (FIG. 6), respectively 67 and 68 (FIG. 7) are attached to the lateral ends of the central part 63 of the slider 62.

In particular, the lateral arm 67 is positioned so that one of its ends is in correspondence with the first end 28 of the fixed guide 22; the lateral arm 68 is positioned so that one of its ends is in correspondence with the first end 29 of the fixed guide 23; the lateral arm 65 is positioned so that one of its ends is in correspondence with the second end 30 of the fixed guide 22; and the lateral arm 66 is positioned so that one of its ends is in correspondence with the second end 31 of the fixed guide 23. Therefore, the two lateral arms 65 and 67 are positioned at a higher level than the two lateral arms 66 and 68 so that the first two can cooperate with the transport members 12 inserted into the first fixed guide 22, which is located on the first movement plane PM1, while the second ones can cooperate with the transport members 12 inserted into the second fixed guide 23, which is located on the second movement plane PM2, as will be described in detail below.

Furthermore, at the end of each of the four lateral arms 65, 66, 67 and 68 there is a thrust head 70 facing toward the two fixed guides 22 and 23.

The internal distance L4 between the thrust surfaces of the thrust heads 70 of each of the two pairs of lateral arms 65 and 66 is equal to the sum of the length L2 of a transport member 12 and the length L3 of the fixed guides 22 and 23.

The slider 62 can move linearly in both directions and parallel to the working line LL, between a first operating position, in which it is completely displaced to the left in FIG. 5, with the lateral arms 67 and 68 outside the second rotating member 39 and the lateral arms 65 and 66 in interference with the first rotating member 38, and a second operating position, in which it is completely displaced to the right in FIG. 5, with the lateral arms 67 and 68 in interference with the second rotating member 39 and the lateral arms 65 and 66 outside the first rotating member 38. The travel S of the slider 62 between its two operating positions is equal to the length L2 of a transport member 12.

The functioning of the apparatus 10 described heretofore, which also corresponds to the method according to the present invention, is as follows.

To illustrate the functioning of the apparatus 10 as a whole, for the convenience of the description, we will now describe the feed cycle of a single transport member 12, because all the other transport members 12 present in the apparatus 10 will behave in the same way.

Let us suppose that the transport member 12 has to transport along the working line LL of the machine 200 (FIG. 2) a plurality of casings 101 from the feed station 201 to the subsequent filling station 202, packaging station 203 and distribution station 204, in order to produce the same number of smoking articles 100, in which the various workings will be carried out, which are not described in detail here, because they fall outside the field of protection of the present invention.

Before starting the various working steps, a plurality of transport members 12 are inserted both on the first fixed guide 22 and also on the second fixed guide 23, so as to occupy them completely. 15

Furthermore, an empty transport member 12, that is, one without any casing 101 on it, is also inserted into each of the rotating guides 50 of the first rotating member 38 which are in the position of expulsion B and position of exclusion C and in the rotating guides 51 of the second rotating member 39 which are in the positions corresponding to the positions A, B and C previously defined with reference to the first rotating member 38. With reference to these positions of the second rotating member 39, it is specified that the positions A and C correspond to those of reception and exclusion of the first rotating member 38, respectively at the top and at the bottom, while position B is inverted with respect to the position of expulsion of FIG. 6, it being understood that it is the front position of the apparatus 10.

In an initial condition, the slider 62 is in the first operating position thereof, that is, displaced completely to the left in FIG. 5, with the lateral arms 67 and 68 outside the second rotating member 39 and the lateral arms 65 and 66 in interference with the first rotating member 38. In this initial condition the two rotating members 38 and 39 are stationary.

A movement step then begins in which all the transport members 12 are displaced simultaneously by a constant pitch P, which is equal to the length L2 of each transport member 12 from the initial position PI to the final position PF along the first fixed guide 22 or from the final position PF to the initial position PI along the second fixed guide 23.

To do this, the electronic control unit 36 maintains the electric motors 46 and 47 stationary and commands the actuator 61 to displace the slider 62 by a pitch P toward its second operating position, in which it is displaced completely to the right in FIG. 5, with the lateral arms 67 and 68 in interference with the second rotating member 39 and the lateral arms 65 and 66 outside the first rotating member 38.

By thrusting the first transport member 12, that is, the one located on the rotating guide 51 of the second rotating member 39, all the other transport members 12 located on the first fixed guide 22 are displaced together toward the first rotating member 38.

With this displacement by a pitch P, the transport member 12 which is initially located in correspondence with the second end 30 (FIG. 5) of the first fixed guide 22 enters the corresponding rotating guide 50 positioned in the position of reception A, at the top (FIG. 6).

Then, the electronic control unit 36 activates the electric motor 46 to rotate the first rotating member 38 by 90° in a counterclockwise direction (FIG. 6).

With this 90° rotation, the transport member 12 which is located in the rotating guide 50 which was positioned in the position of reception A moves to the position of expulsion B, at the front, while at the same time the two transport members 12 which were in positions B and C (respectively expulsion and discard position) have moved respectively to positions C and D, that is, to the positions of discard and release.

At this point, the electronic control unit 36 maintains the electric motors 46 and 47 stationary and commands the actuator 61 to carry out the reverse displacement, by a pitch P, of the slider 62 toward its first operating position, in which it is displaced completely to the left in FIG. 5.

With this reverse displacement, the lateral arm 66 thrusts the transport member 12 which was in the position of release D of the first rotating member 38 toward the left, making it enter into the second fixed guide 23.

Consequently, all the transport members 12 located in the latter are displaced toward the initial position PI and, in particular the one located near the first end 29 of the second fixed guide 23 enters the corresponding rotating guide 51 of the second rotating member 39 which is in position D.

Subsequently, the electronic control unit 36 activates the electric motor 47 to rotate the second rotating member 39 by 90° in a counterclockwise direction (FIG. 7).

With this 90° rotation the transport member 12 which is located in the rotating guide 51 which was positioned in position B moves to position A, at the top, while at the same time the two transport members 12 which were in positions C and D have moved to positions B and C respectively.

In this way, a cycle of advance of the first transport member 12 under consideration has been completed, which is now located in correspondence with the feed station 201 (FIG. 2) at the beginning of the first fixed guide 22.

From tests carried out by Applicant, it has emerged that each cycle of advance can be carried out in a very short time, in the order of two seconds, so that, since four casings 101 are processed at a time, mounted on each transport member 12, a very high hourly production was obtained, in the order of about 7,000 smoking articles 100.

In this position, an empty casing 101 is loaded in each of the four seatings 13 of the transport member 12 in any known manner.

On the rotating guide 51 which is now in position A of the second rotating member 39 (FIG. 7) there is now another transport member 12, so that the cycle of advance is repeated for the latter and so on, continuously for all the other transport members 12.

It should be noted that, in this way, each transport member 12 with the casings 101 on board is made to advance step by step along the first fixed guide 22 to the final position PF, while the empty transport members 12 return step by step, from the final position PF to the initial position PI along the second fixed guide 23. During the outward travel the smoking articles 100 are completed by the work stations 202 and 203 of the machine 200.

At the end of these workings, the electronic control unit 36, on the basis of signals provided by the control device 35, provides to coordinate the expulsion of the smoking articles 100 present on board the transport member 12 which has reached the first rotating member 38 in the final position PF.

In particular, the smoking articles 100 which were considered non-defective by the control device 35 are expelled to the conveyor belt 55 (FIGS. 1 and 5) of the distribution station 204, by means of the first plurality of nozzles 56 (FIG. 6) positioned in correspondence with the position of expulsion B of the first rotating member 38, while the smoking articles 100 which have been considered defective by the same control device 35 are expelled downward, by means of the second plurality of nozzles 57 positioned in correspondence with the position of exclusion C of the first rotating member 38.

It should be noted that, in the embodiment described here, each transport member 12, when it arrives in the final position PF, performs a rotation of 270° with respect to the position of reception A in which the first fixed guide 22 is located, before reaching the position of release D, in which it is inserted into the second fixed guide 23.

The disposition of the second fixed guide 23, substantially at 90° with respect to the first fixed guide 22 toward the rear of the apparatus 10, advantageously allows to considerably reduce the overall sizes of the latter and also, possibly, of the machine 200 with which it is associated, or inserted.

Furthermore, the transport members 12 moved on the second fixed guide 23 are protected from any dust, or waste material, coming from the work stations 201, 202 and 203 located above the first fixed guide 22.

Another advantage deriving from the particular disposition of the second fixed guide 23 with respect to the first fixed guide 22 is that all the transport members 12, before being inserted into the second fixed guide 23, pass from the position C of the first rotating member 39, so that they are disposed with their seatings 13 facing downward and any possible working residue is expelled from the latter in a natural way by the effect of gravity.

It is clear that modifications and/or additions of parts may be made to the apparatus 10 as described heretofore, without departing from the field and scope of the present invention as defined by the claims

It is also clear that, although the present invention has been described with reference to some specific examples, a person of skill in the art shall certainly be able to achieve many other equivalent forms of apparatus and/or method for transporting smoking articles, hence all coming within the field of protection of the present invention.

In the following claims; the sole purpose of the references in brackets is to facilitate reading: they must not be considered as restrictive factors with regard to the field of protection claimed in the claims themselves.

1. Transport apparatus for transporting objects, comprising a plurality of transport members independent of each other and configured to each carry one or more of said objects along a working line from an initial position to a final position, said transport apparatus also comprises first guide means parallel to said working line and configured to sequentially guide said plurality of transport members from said initial position to said final position; second guide means parallel to said first guide means and configured to sequentially guide said plurality of transport members from said final position to said initial position; first displacement means and second displacement means configured to selectively displace said plurality of transport members from one to the other of said first and second guide means, wherein said first displacement means comprise a first rotating member disposed in correspondence with said final position and configured to selectively displace, one at a time, each of said transport members from said first guide means to said second guide means, and said second displacement means comprise a second rotating member disposed in correspondence with said initial position and configured to selectively displace, one at a time, each of said transport members from said second guide means to said first guide means, wherein said first rotating member is configured to selectively rotate, by means of a step-wise rotation about an axis of rotation, between a position of reception and a position of release passing through a position of expulsion and a position of exclusion, different from the position of expulsion, and in that it also comprises a control device configured to detect any possible defects in the objects moved along said first guide means, expulsion means configured to expel the objects from the transport member toward an exit conveyor, when the transport member arrives in the position of expulsion, and discarding means configured to expel the objects which the control device has detected to be defective, from the transport member, when the transport member arrives in the position of exclusion.

2. Transport apparatus as in claim 1, wherein the position of expulsion is located upstream of the position of exclusion when the transport member passes from the position of reception to the position of release.

3. Transport apparatus as in claim 1, wherein said first rotating member performs a rotation of 270° when it rotates between said position of reception and said position of release.

4. Transport apparatus as in claim 1, wherein said first rotating member and said second rotating member rotate about the axis of rotation disposed parallel to said first and second guide means, so that said transport members are selectively displaced between said guide means, with a displacement which maintains the relative orientation of said transport members with respect to said working line unchanged.

5. Transport apparatus as in claim 1, wherein said first rotating member and said second rotating member each comprise a plurality of rotating guides parallel to said first and second guide means, angularly distanced from each other in a uniform manner and each having substantially the same cross-section as said first and second guide means, in order to temporarily house one of said transport members, wherein each rotating guide is rotatable about the axis of rotation to selectively bring itself into alignment with said first guide means or with said second guide means.

6. Transport apparatus as in claim 1, wherein said second guide means are offset both horizontally and also vertically with respect to said first guide means.

7. Transport apparatus as in claim 1, wherein between the position of reception and the position of expulsion the transport member performs a 90° rotation.

8. Transport apparatus as in claim 1, wherein said expulsion means and said discarding means are of the pneumatic type, being configured as nozzles capable of selectively emitting a flow of air under pressure that allows to expel said objects from said transport members.

9. Transport apparatus as in claim 1, wherein each of said plurality of transport members comprises longitudinal guide elements, wherein said first and second guide means have a respective cross-section shaped so as to house guide members configured to cooperate with said longitudinal guide elements to allow said first and second guide means to slide only in a longitudinal direction.

10. Transport apparatus as in claim 1, further comprising movement means, configured to selectively and alternatively move a first plurality of said transport members along said first guide means from said initial position to said final position and a second plurality of said transport members along said second guide means from said final position to said initial position and in that said movement means perform an alternating cyclic movement.

11. Transport apparatus as in claim 10, wherein said movement means comprise first thrust means positioned in correspondence with said final position and second thrust means positioned in correspondence with said initial position and in that said first thrust means and said second thrust means are disposed at a fixed reciprocal distance from each other and are configured to be moved in a coordinated manner, such that the reciprocal distance between said first thrust means and said second thrust means is fixed.

12. Transport apparatus as in claim 1, wherein said expulsion means and said discarding means are fixed and disposed in proximity to said first rotating member

13. Method for transporting objects, preferably smoking articles, comprising a transport step in which one or more of said objects disposed on a plurality of transport members are transported sequentially along a working line from an initial position to a final position, guided by first guide means parallel to said working line; a return step in which second guide means parallel to said first guide means sequentially guide said plurality of transport members from said final position to said initial position; and a displacement step, interposed between said transport step and said return step, in which displacement means configured as rotating members selectively displace said plurality of several transport members, one at a time, from one to the other of said first and second guide means, said displacement step provides to rotate said rotating members about an axis of rotation, disposed parallel to said first and second guide means, so that said transport members are selectively displaced from said first to said second guide means, or vice versa, with a movement which maintains the relative orientation of said transport members with respect to said working line unchanged, characterized in that said rotating members comprise a first rotating member configured to selectively rotate at least between a position of reception and a position of release passing through a position of expulsion and a position of exclusion, different from the position of expulsion, and in that it comprises a step of detecting, upstream of said first rotating member, the presence of a possible defect in the objects moved along said first guide means, an expulsion step to expel the objects from the transport member that has arrived in the position of expulsion toward an exit conveyor, and a discard step to remove from the transport member the objects that the control device has detected to be defective, when the transport member arrives in the position of exclusion.

14. Method as in claim 13, wherein during said displacement step, the first rotating member rotates by 270° to pass from the position of reception to the position of release.

15. Machine for automatically producing smoking articles each having at least one casing, comprising at least one feed station configured to feed said casings, at least one filling station configured to fill said casings with smoking material, at least one packaging station configured to package said smoking articles by closing one end of said casings and at least one transport apparatus configured to transport said casings from said feed station to at least one of said filling or packaging stations, wherein in that said transport apparatus is as in claim 1.
